(19) United States
(12) Patent Application Publication
(10) Pub. No.: US 2019/0287052 A1
(43) Pub. Date: Sep. 19, 2019

(54) BEACON ENABLED SYSTEM FOR DATA RETRIEVAL BASED ON LOCATION

(71) Applicant: ORACLE INTERNATIONAL CORPORATION, Redwood Shores, CA (US)

(72) Inventors: Sushmitha SUNDAR, Bangalore (IN); Manish SOMANI, Parker, CO (US); Rahul DUTTA, Bangalore (IN)

(21) Appl. No.: 15/923,348

(22) Filed: Mar. 16, 2018

(51) Int. Cl. G06Q 10/08; G06F 17/30; H04W 4/02; G01C 21/20; G06Q 10/06

(52) U.S. Cl. CPC G06Q 10/087; G06F 17/30241; G06F 3/04847; G01C 21/206; G06Q 10/06311; H04W 4/02

(57) ABSTRACT

Systems, methods, and other embodiments associated with data retrieval based upon location are described. In one embodiment, a method includes controlling a wireless receiver to listen for beacon signals transmitted by beacon devices located at different locations within a site. The example method may also include evaluating a first beacon signal to identify a site identifier of the site. The example method may also include retrieving asset information for assets located at the site. The example method may also include constructing and rendering a user interface populated with the asset information. In this way, a user is routed through the site to a target asset using the user interface.

### BACKGROUND

A computing system, such as an enterprise resource planning (ERP) system, can be used to create, store, retrieve, and record progress of work orders that are be performed upon assets of a company. For example, a user can submit a work order ticket to create a work order for fixing a laptop that has a cracked screen. The work order and/or other work orders can be assigned to a technician capable of completing the assigned work orders. The work orders assigned to the technician can correspond to assets located in various locations, such as in different buildings, floors of a building, etc. Also, some types of assets are mobile, such as the laptop that can be carried around by the user. Thus, locating exact locations of assets that are to be worked on in satisfaction of the work orders can be difficult for the technician to discern.

The technician may approach a site within which the laptop and/or other assets are located. The technician has to manually access a computer, connect the computer to the ERP system, and manually search for work orders assigned to the technician. The technician must then manually filter the work orders in order to identify those work orders that are to be performed that this site. In order to query the ERP system to identify assigned work orders for the site, the technician must know a site identifier of the site and asset identifiers of those assets that are to be worked on by the technician. This is a cumbersome manual task that can waste time and computing resources, such as due to manual input errors.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates an embodiment of a system associated with data retrieval based upon location.

FIG. 2 illustrates an embodiment of a method associated with data retrieval based upon location.

FIG. 3A illustrates an embodiment of a system associated with data retrieval based upon location, where a user interface is rendered on a computing device.

FIG. 3B illustrates an embodiment of a system associated with data retrieval based upon location, where a user interface is populated with asset information of a first asset and a site map.

FIG. 3C illustrates an embodiment of a system associated with data retrieval based upon location, where a user interface is populated with asset information of a second asset and a site map.

FIG. 3D illustrates an embodiment of a system associated with data retrieval based upon location, where a user interface is populated with asset information of a first asset and a second asset and a site map.

FIG. 4 illustrates an embodiment of a non-transitory computer-readable medium.

FIG. 5 illustrates an embodiment of a computing system configured with the example systems and/or methods disclosed.

FIG. 6 illustrates an embodiment of an integrated business system and an enterprise network in which an embodiment of the invention may be implemented.

FIG. 7 illustrates an embodiment of a multi-tenant distributed computing service platform.

### DETAILED DESCRIPTION

Computerized systems and methods are described herein that provide for data retrieval based upon location. In particular, a beaconing system is employed to determine what asset and work order information to retrieve and display on a computing device in an automated manner in order to improve existing technological processes for work order retrieval. Existing technological processes for work order retrieval require a user to access a computer to connect the computer to a remote computing system, such as an enterprise resource planning (ERP) system that stores work orders. The user must interface with the ERP system to query the ERP system for work orders assigned to the user. The user must then filter the work orders to identify particular work orders for assets located at a site where the user is going to perform such work orders. This manual searching and filter is cumbersome and error prone because the user must know and input site identifiers, asset identifiers, and/or other information in order to retrieve relevant work orders from the ERP system.

Accordingly, as provided herein, a communication module executing on a computing device is configured to detect beacon signals transmitted from beacon devices located at different locations within a site. The beacon signals are parsed to identify a site identifier of the site, asset identifiers of assets within the site, and identifiers of beacon devices that emitted such beacon signals. This information is used to determine a current location of the computing device within the site relative to the beacon devices as the computing device moves around the site. The information is also used to selectively retrieve asset information of assets located at the site having open work orders assigned to a user of the computing device. Locations of assets and beacon devices relative to the current location of the computing device are displayed through an electronic site map of the site as asset indicators, beacon indicators, and a device indicator. The electronic site map is updated as the computing device moves around the site. In this way, asset information, work order information, and the electronic site map are rendered through the user interface of the computing device in an automated manner that does not require manual searching for such information. Thus, operation of the computing device is improved with new functionality to provide automated information that is contextually relevant to a current location of the computing device.

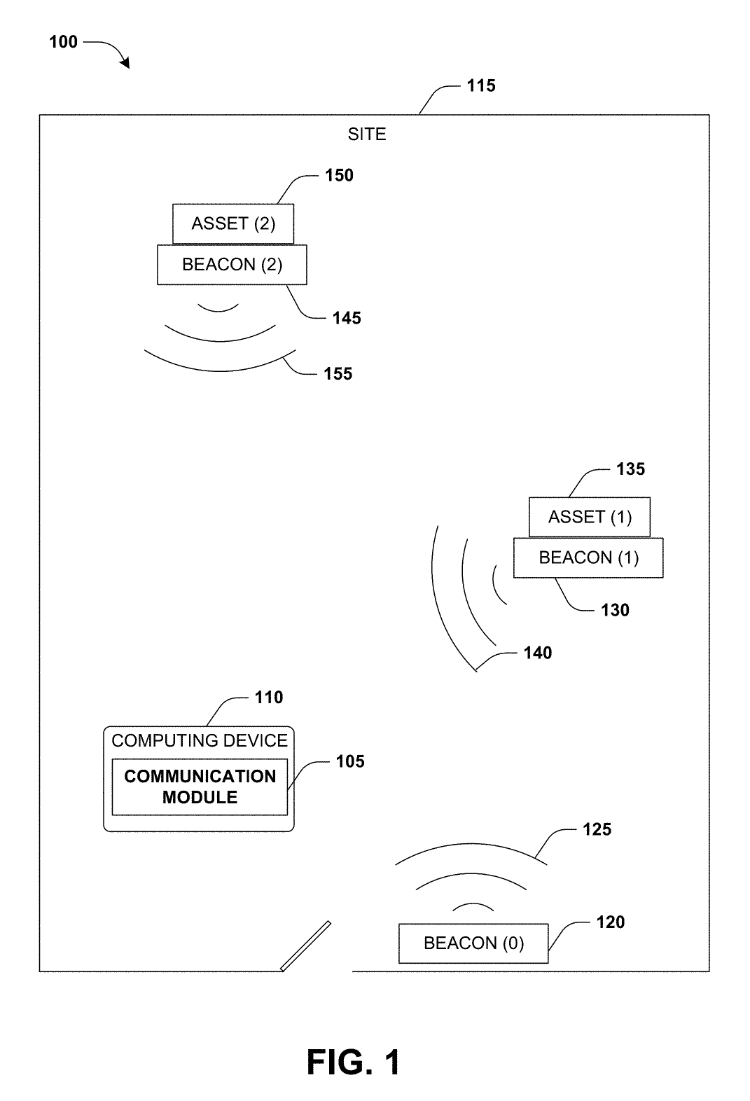

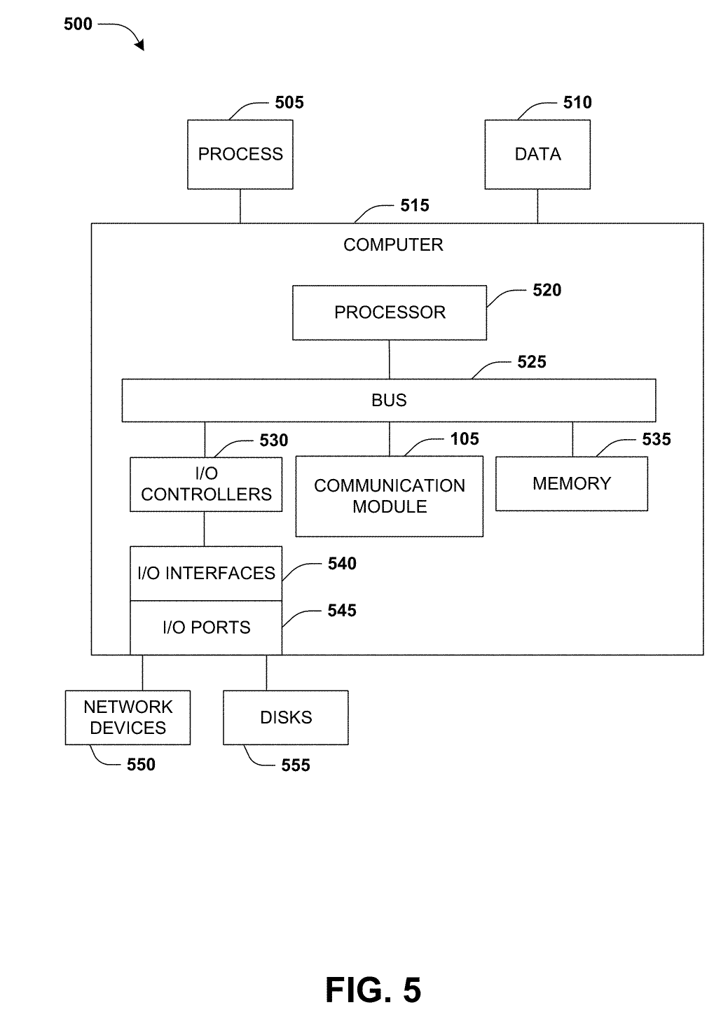

With reference to FIG. 1, one embodiment of a system 100 associated with data retrieval based upon location is illustrated. The system 100 may be implemented as a communication module 105 hosted on a computing device 110, such as a mobile phone, a tablet, a laptop, a wearable device, or any other computer such as the computer 515 of FIG. 5. The system 100 may be associated with beacon devices placed at different locations around a site 115, such as a building, an outdoor location, an amusement park, etc. A beacon device comprises transmitter hardware capable of emitting beacon signals that can be detected by other computing devices, such as the computing device 110. The beacon device can transmit beacon signals that deliver proximity-based and context-aware messages that can be used by receiving devices to determine their proximity to the beacon device. Thus, the computing device 110 can “see” the beacon device when the computing device 110 is close enough to the beacon device to receive beacon signals transmitted from the beacon device. The beacon device can be configured to repeatedly transmit beacon signals so that the computing device 110 can detect the beacon device in real time as the computing device 110 moves around the site 115. The beacon device can utilize Bluetooth technology to transmit beacon signals so that any computing device with Bluetooth functionality can receive the beacon signals.

In one embodiment, a beacon signal comprises a single identifier number of a beacon device, and that single identifier number comprises one or more parts, such as a universal unique identifier (UUID) of the beacon device, a major number, and/or a minor number. Each part can be customized to convey select types of information. In one example, the major number can be configured to comprise a site identifier and the minor number can be configured to optionally comprise an asset identifier if the beacon device is associated with an asset. In another example, the major number can be used to indicate a beacon device type, such as whether the beacon device is a site beacon at an entrance of the site and thus is not associated with an asset or an asset beacon that is associated with an asset. For example, the major number can be set to a value of 1 or any other value to identify the beacon device as a site beacon and set to a value of 2 or any other value to identify the beacon device as an asset beacon. In this way, each part of the single identifier number can be tailored to convey select types of information.

At the site 115, a beacon device 120 is placed at an entrance to the site 115. When the computing device 110 comes within communication range of the beacon device 120, the communication module 105 is able to detect and receive beacon signals 125 emitted by the beacon device 120. The communication module 105 parses the beacon signals 125 to identify a site identifier of the site 115 and an identifier of the beacon device 120. Using the site identifier, the communication module 105 can query a data structure or remote service using the site identifier to identify the site 115 at which the computing device 110 is located. In one embodiment, the data structure is hosted locally on the computing device 110, such as within a table or database where site identifiers are mapped to site names/descriptions. In another embodiment, the remote service is hosted by a remote computing device, such as an enterprise resource planning (ERP) system. Using the identifier of the beacon device 120, the communication module 105 can query the data structure or the remote service using the identifier to identify the beacon device 120, a location of the beacon device 120 within the site 115, and/or other information about the beacon device 120. In one embodiment, the data structure may comprise a table or database where identifiers of beacon devices are mapped to beacon device names/descriptions, beacon device locations, assets associated with beacon devices, etc.

The communication module 105 may retrieve asset information of assets within the site 115 from a remote computing device, such as the ERP system. The asset information may describe assets within the site 115, such as for assets having open work orders that are assigned to the user of the computing device 110. The asset information is rendered through a user interface displayed on a display of the computing device 110, such as through a list identifying an asset 135 and an asset 150, descriptions of those assets, and work orders to be performed for those assets. In one embodiment, an electronic site map of the site 115 is also rendered on the display to show locations of the assets within the site 115 relative to the computing device 110.

As the computing device 110 moves within the site 115, the electronic site map and/or the asset information is updated with locations of assets relative to the computing device 110 and/or with information of nearby assets. In particular, as the computing device 110 comes within communication distance of a different beacon device, the communication module 105 will be able to detect and receive beacon signals emitted from that beacon device. The beacon signals are parsed to identify an identifier of that beacon device, which can be used to determine a location of the beacon device, and thus a location of the computing device 110 within the site 115 relative to the beacon device. Information of an asset associated with the beacon device may be retrieved and rendered through the user interface and/or the electronic site map. In this way, the user interface and the electronic site map are updated in real-time in an automated manner with asset information of nearby assets as the computing device 110 moves around the site 115.

In one embodiment, as the computing device 110 approaches a beacon device 130 associated with an asset 135, the communication module 105 is able to detect and receive beacon signals 140 emitted by the beacon device 130. The communication module parses the beacon signals 140 to obtain an identifier of the beacon device 130 and an asset identifier of the asset 135. The identifier and asset identifier can be used to query data structures to identify information relating to the asset 135 and the beacon device 130, such as locations of the asset 135 and the beacon device 130, open work orders for the asset 135, etc. Such information can be used to update the user interface and/or the electronic site map, such as where the work order is displayed within the user interface and locations of the asset 135 and the beacon device 130 are populated within the electronic site map. Similarly, the user interface and/or the electronic site map may be updated with information relating to a beacon device 145 and/or an asset 150 associated with the beacon device 145 when the computing device 110 comes within range of the computing device 110 so that the communication module 105 can receive beacon signals 155 from the beacon device 145.

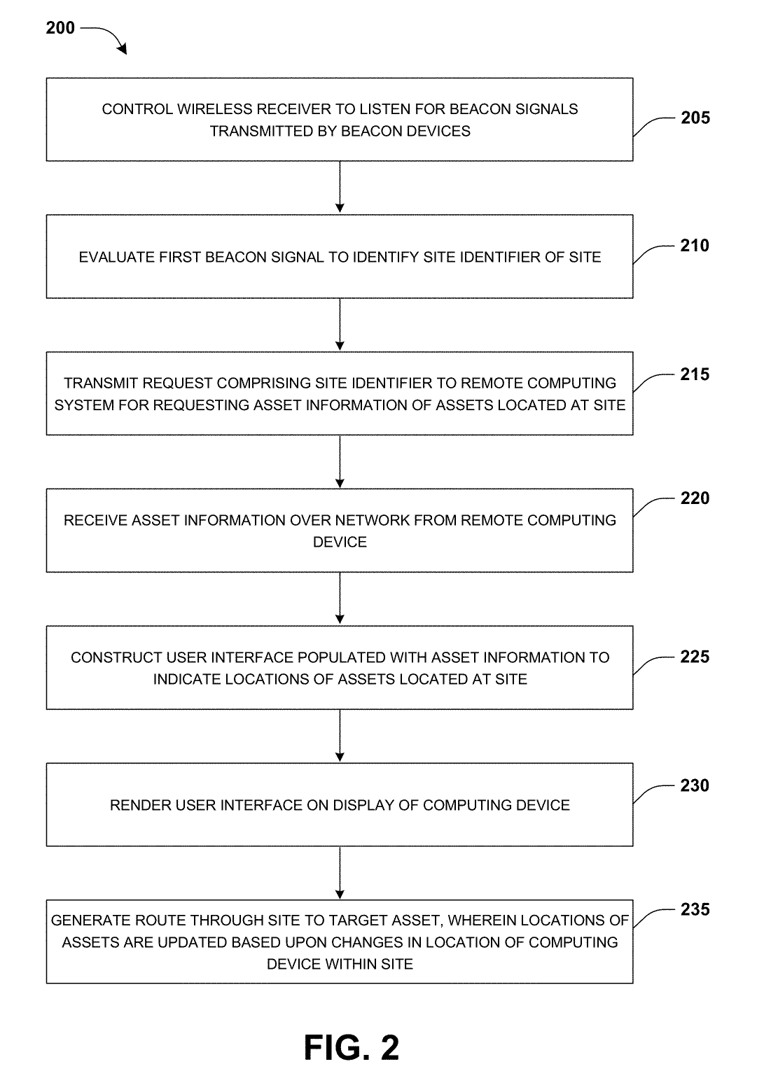

With reference to FIG. 2, one embodiment of a computer implemented method 200 associated with data retrieval based upon location is illustrated. In one embodiment, the method 200 is performed by the communication module 105 utilizing various computing resources of the computer 515 and/or other computers, such as the processor 520 for executing instructions associated with controlling a wireless receiver, evaluating beacon signals, and constructing and rendering a user interface. Memory 535 and/or disks 555 are used for storing asset information and/or other data. Network hardware is used for communicating data structures and/or other data between the computer 515 and remote computers over a network, such as for selectively retrieving asset information from a remote computing device such as an ERP system. The method 200 is triggered upon execution of an application on the computing device 110 that implements the communication module 105.

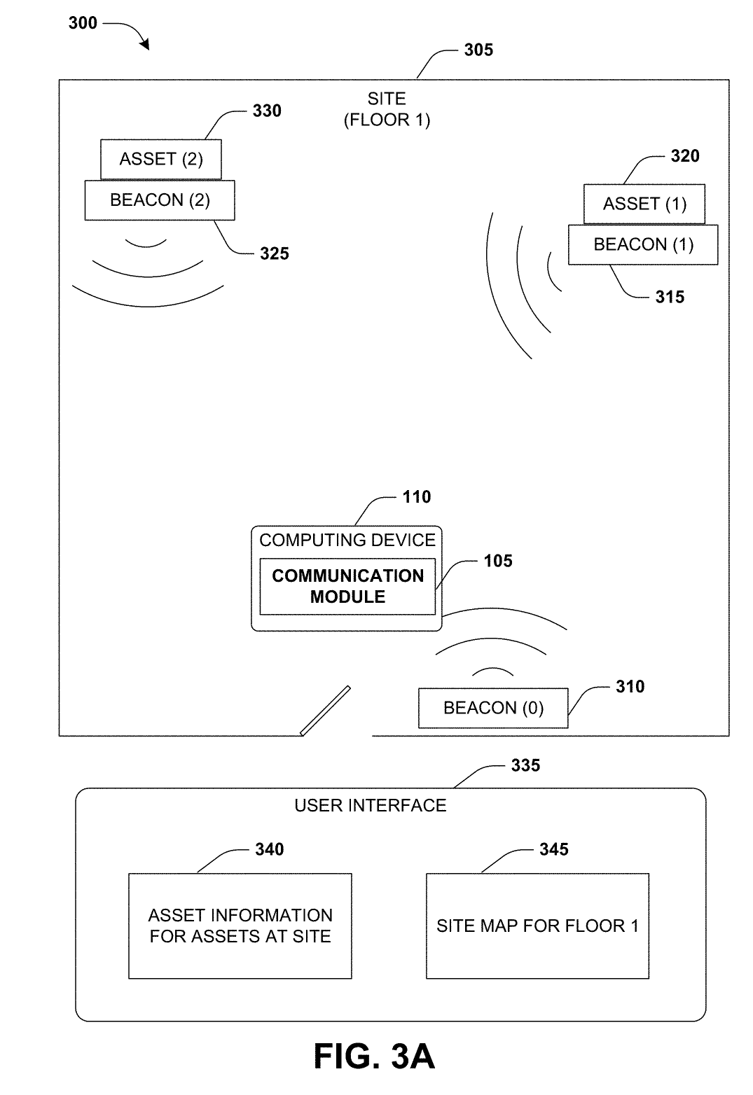

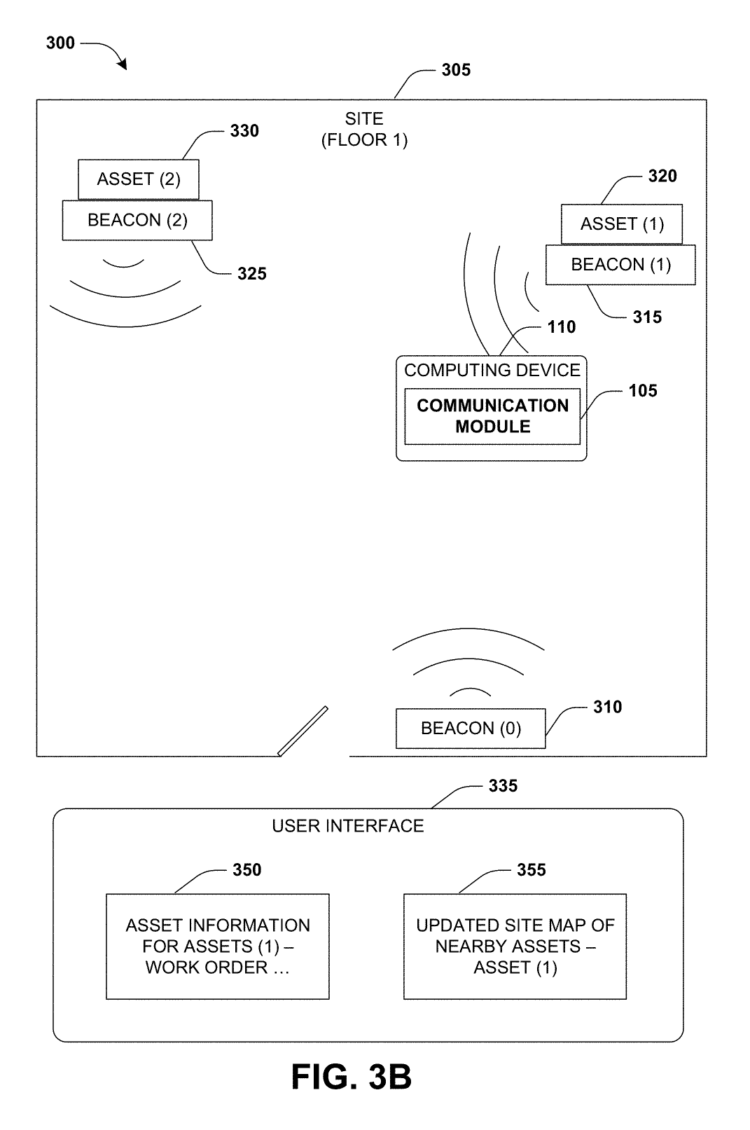

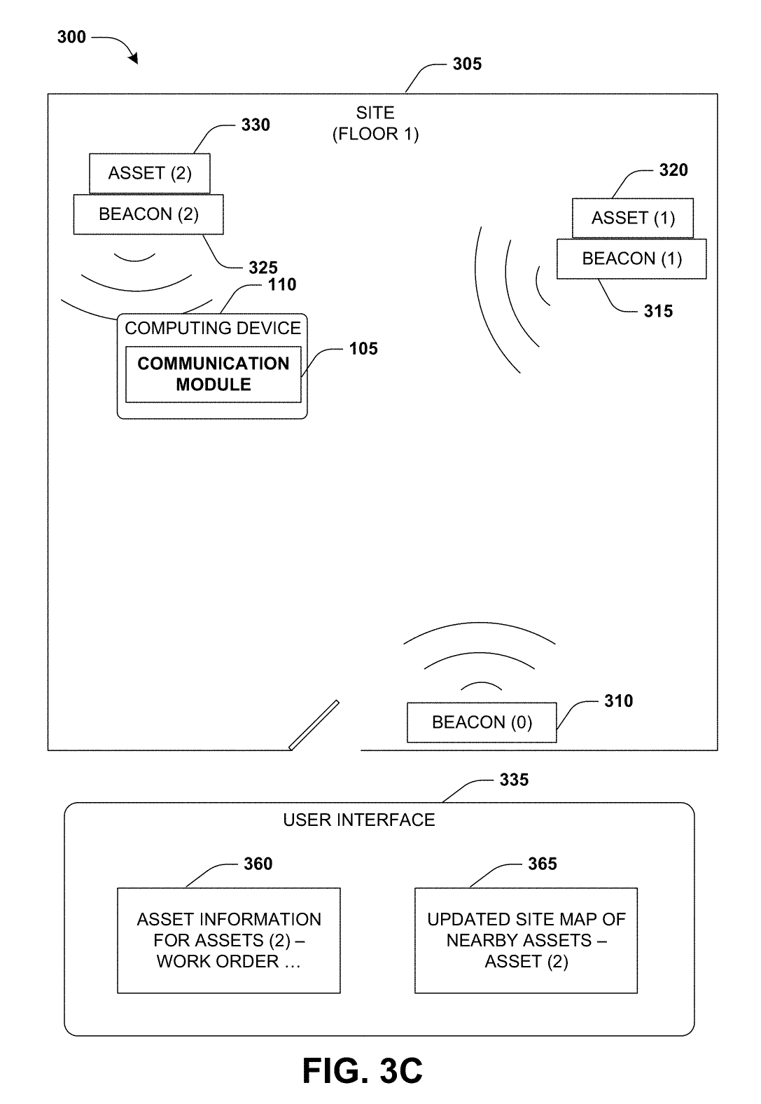

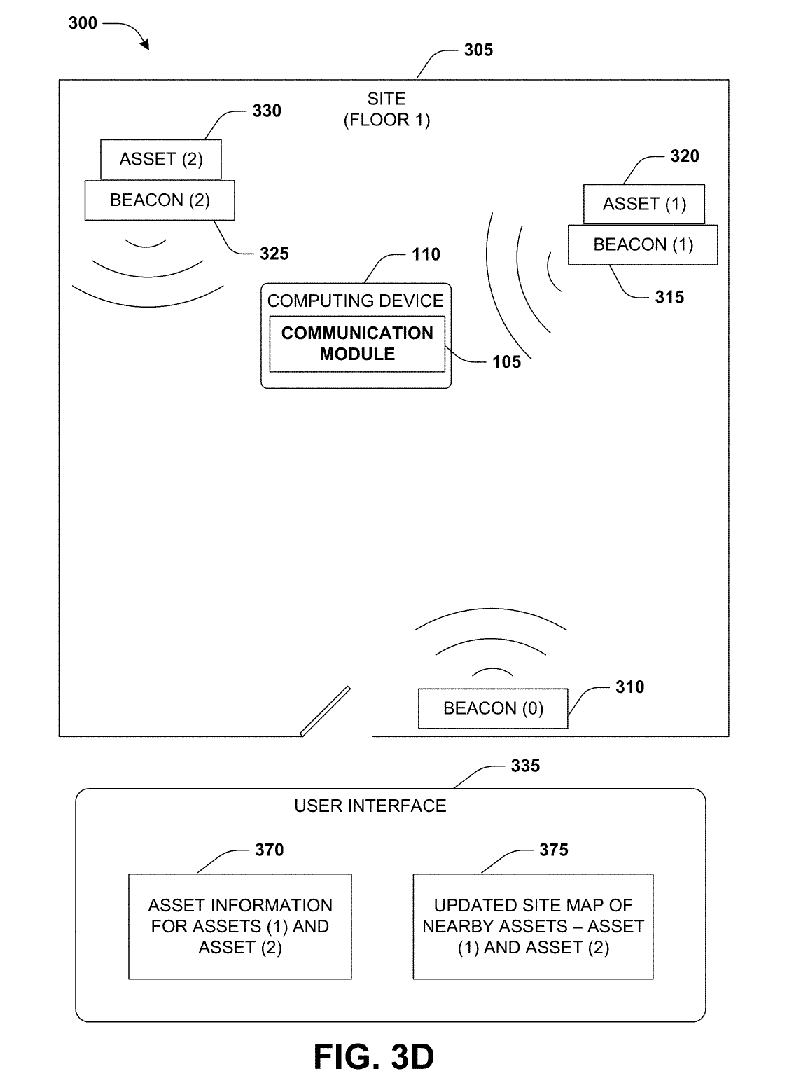

Beacon devices are positioned at different locations within a site 305, such as a beacon device 310, a beacon device 315, and a beacon device 325 within a first floor of a building, as illustrated by the example system 300 of FIG. 3A. The beacon device 310 is configured to transmit beacon signals encoded with information about the beacon device 310. In one embodiment, a first portion of a beacon signal is encoded with an identifier of the beacon device 310, a second portion of the beacon signal is encoded with a major number mapped to a site identifier of the site 305, and a third portion of the beacon signal is optionally encoded with a minor number mapped to an asset identifier of an asset associated with the beacon device 310. Since the beacon device 310 is not associated with an asset, but is instead installed near an entrance of the site 305 as an indicator to computing devices that they have entered the site 305, the third portion may be encoded with placeholder/dummy values or excluded from the beacon signal.

The beacon device 315 is associated with an asset 320 and is configured to transmit beacon signals encoded with information about the beacon device 315 and the asset 320. In one embodiment, a first portion of a beacon signal is encoded with an identifier of the beacon device 315, a second portion of the beacon signal is encoded with a major number mapped to the site identifier of the site 305, and a third portion of the beacon signal is encoded with a minor number mapped to an asset identifier of the asset 320.

The beacon device 325 is associated with an asset 330 and is configured to transmit beacon signals encoded with information about the beacon device 325 and the asset 330. In one embodiment, a first portion of a beacon signal is encoded with an identifier of the beacon device 325, a second portion of the beacon signal is encoded with a major number mapped to the site identifier of the site 305, and a third portion of the beacon signal is encoded with a minor number mapped to an asset identifier of the asset 330. It may be appreciated that any number of beacon devices may be located within the site 305. Beacon devices can be free standing, attached to or installed within a wall or structure, implemented as a standalone device, incorporated into another device, attached to or installed within an asset, etc.

The computing device 110, such as a mobile device of a technician that is to perform work orders for the asset 320 and the asset 330 within the site 305, is configured to execute the communication module 105 for detecting and processing beacon signals received from the beacon devices.

At 205, the communication module 105 controls a wireless receiver of the computing device 110 to listen for beacon signals transmitted by beacon devices located at different locations within the site 305. In one embodiment, the communication module 105, such as the application executing on the computing device 110, accesses and controls a Bluetooth receiver of the computing device 110 using a Bluetooth driver installed within an operating system of the computing device 110. Commands and functions of the Bluetooth driver can be used by the communication module 105 to obtain beacon signals received by the Bluetooth receiver. In this way, the communication module 105 controls the wireless receiver to receive beacon signals and provide the communication module 105 with access to the received beacon signals.

In response to receiving, by the wireless receiver, a first beacon signal from the beacon device 310, the first beacon signal is evaluated to identify a site identifier of the site 305, at 210. In particular, the communication module 105 parses the first beacon signal to identify the site identifier and an identifier of the beacon device 310. In one embodiment where the first beacon signal comprises a sequence of characters, a first portion of the sequence is parsed to extract the identifier of the beacon device 310 and a second portion of the sequence is parsed to extract a major number mapped to the site identifier of the site 305. Since the beacon device 310 is not associated with a particular asset, a third portion of the sequence may comprise placeholder/dummy values that indicate to the communication module 105 that the beacon device 310 is not associated with an asset. Thus, the communication module 105 parses the third portion of the sequence to identify a minor number having the placeholder/dummy values. In one embodiment, in response to receiving the first beacon signal of the beacon device 310 not associated with an asset and located at the entrance of the site 305, the communication module 105 renders a site description user interface populated with a description of the site, such as a welcome message and information about the site 305

At 215, the communication module 105 transmits, over a network, a request comprising the site identifier to a remote computing system for requesting asset information 340 of assets located at the site 305. The communication module 105 utilizes a representational state transfer (REST) application programming interface (API) to transmit the request over the network to the ERP system hosted by the remote computing device. The request comprises an instruction for the ERP system to query one or more data structures for asset information associated with assets of the site 305, such as descriptions of assets with open work orders, the open work orders, locations of the assets, etc. In one embodiment, the request comprises an identifier of the technician so that asset information is only requested for assets having open work orders assigned to the technician. In one embodiment, the request comprises a request for an electronic site map 345 of the site 305 (e.g., a request for data used to construct the electronic site map 345). The electronic site map 345 may depict walls, floors, doorways, assets, beacon devices, and/or other objects within the first floor of the site 305.

At 220, the asset information 340 is received over the network from the remote computing device. In one embodiment, the ERP system queries the one or more data structures to determine that the asset 320 and the asset 330 are located within the site 305 and have open work orders assigned to the technician. Accordingly, the ERP system transmits descriptions, images, or other information of the asset 320 and the asset 330 as the asset information 340. The ERP system may transmit the open work orders for the asset 320 and the asset 330 as the asset information 340. In this way, the communication module 105 receives the asset information 340 from the ERP system over the network. In one embodiment where the electronic site map 345 was requested, the ERP system transmits the electronic site map 345 to the computing device 110.

At 225, the communication module 105 constructs a user interface 335 with the asset information 340 to indicate locations of assets within the site 305 relative to the computing device 110 so that the assets can be located within the site 305 by the technician. In one embodiment, a description of all assets, assets with open work orders, nearby assets associated with beacon devices in communication distance with the computing device 110, or assets with open work orders assigned to the technician are populated within the user interface 335. Thus, various granularities of asset information can be displayed through the user interface 335. In one embodiment, images of the assets, locations of the assets, and/or employees in possession of such assets may be populated within the user interface 335 to aid the technician in finding the assets. In one embodiment, open work orders for the assets are populated with the user interface 335.

At 230, the user interface 335 is rendered on a display the computing device 110. The user interface 335 may be rendered through the application implementing the communication module 105. The user interface 335 may be rendered in an automated manner without the technician manually interfacing with the application to search for and retrieve the asset information 340 populated within the user interface 335. That is, the listening for beacon signals, retrieval of the asset information 340 and the electronic site map 345, and the construction of the user interface 335 can be performed without manual input or intervention, which greatly reduces the error and manual burden on the technician for search for such information.

In one embodiment, the electronic site map 345 is rendered on the display of the computing device 110. The electronic site map 345 is populated with asset indicators of assets within the site 305, such as for assets that are within a threshold distance of the computing device 110, for all assets within the site 305, or for assets with open work orders assigned to the technician. The threshold distance corresponds to a distance over which the computing device 110 is capable of receiving beacon signals from beacon devices associated with corresponding assets. The asset indicators are populated within the electronic site map 345 at locations corresponding to locations of the assets within the site 305. In one embodiment, the locations may be specified through the asset information 340 received from the remote computing device. In another embodiment, the locations may be determined in real-time based upon beacon signals received from beacon devices associated with such assets. For example, the communication module 105 may determine that the computing device 110 is near the asset 330 when the communication module 105 detects beacon signals from the beacon device 325 associated with the asset 330. Thus, if the asset 330 is mobile, such as a laptop, then the computing device 110 can detect a current location of the asset 330 in relation to the computing device 110 based upon the ability to receive or not receive beacon signals from the beacon device 325.

The electronic site map 345 is populated with a device indicator to indicate a current location of the computing device 110 within the site 305. The current location may be determined based upon locational information extracted from beacon signals received from beacon devices. In one embodiment, when the computing device 110 comes within communication range of the beacon device 315, the communication module 105 will start receiving beacon signals from the beacon device 315. The beacon signals are indicative of the computing device 110 being near a location of the beacon device 315.

At 235, a route through the site 305 to a target asset is generated and rendered on a display of the computing device 110. In one embodiment, the technician may select the target asset from within the asset information 340 or may select an asset indicator of the target asset from the electronic site map 345. In response to the selection, a path may be created (e.g., drawn) within the electronic site map 345 from a device indicator of the computing device 110 to the asset indicator of the target asset within the electronic site map 345. The path may be updated in real-time as the computing device 110 moves within the site 305. In this way, the technician is routed to the target asset through the user interface 335.

In one embodiment, the communication module 105 is configured to continuously monitor, using the wireless receiver, to detect beacon signals from beacon devices as the computing device 110 moves around the site 305. That is, the communication module 105 instructs the wireless receiver to continuously listen for beacon signals using a transceiver of the wireless receiver. In one example, the communication module 105 may periodically query the wireless receiver to determine if a new beacon signal has been received. In another example, the communication module may register with the wireless receiver to receive push notifications from the wireless receiver when a new beacon signal is received. In this way, the computing device 110 is listening for new and/or different beacon signals from other devices in the area as the computing device 110 is moved. Suppose the computing device 110 moves away from the beacon device 310 and towards the beacon device 315, as illustrated in FIG. 3B. Upon detecting a beacon signal emitted by the beacon device 315, the communication module 105 parses the beacon signal to identify an identifier of the beacon device 315, the site identifier of the site 305, an asset identifier of the asset 320 associated with the beacon device 315, and/or other information.

The communication module 105 transmits a request to the remote computing device to retrieve updated asset information 350 comprising asset information of the asset 320 and an updated electronic site map 355 (e.g., data used to construct/render the updated electronic site map 355). The request may comprise the identifier of the beacon device 315, the site identifier of the site 305, the asset identifier of the asset 320, and/or other information such as an identifier of the technician that can be used to determine whether there are open work orders for the asset 320 that are assigned to the technician.

The updated asset information 350 may comprise work order information of a work order for the asset 320, such as a work order number of the work order, a description of the work order, a status of the work order, a priority of the work order, and an asset description of the asset 320. Thus, the work order information may be populated within the user interface 335. The updated site map 355 may display the device indicator located near an asset indicator of the asset 320 because the computing device 110 is now within communication range of the beacon device 315. In this way, the user interface 335 is updated with the updated asset information 350 and the updated electronic site map 355 depicting the device indicator as being located nearby the asset 320. In one embodiment, the work order is displayed in response to the technician selecting the asset 320 from the updated asset information 350 or selecting an asset indicator of the asset 320 populated within the updated site map 355.

The computing device 110 may move away from the beacon device 315 such that the communication module 105 no longer receives beacon signals from the beacon device 315, as illustrated by FIG. 3C. The computing device 110 may move towards the beacon device 325 associated with the asset 330. Upon detecting a beacon signal emitted by the beacon device 325, the communication module 105 parses the beacon signal to identify an identifier of the beacon device 325, the site identifier of the site 305, an asset identifier of the asset 330 associated with the beacon device 325, and/or other information. The communication module 105 transmits a request to the remote computing device to retrieve updated asset information 360 comprising asset information of the asset 330 and an updated electronic site map 365 (e.g., data used to construct/render the updated electronic site map 365). The request may comprise the identifier of the beacon device 325, the site identifier of the site 305, the asset identifier of the asset 330, and/or other information such as the identifier of the technician that can be used to determine whether there are open work orders for the asset 330 that are assigned to the technician.

The updated asset information 360 may comprise work order information of a work order for the asset 320, such as a work order number of the work order, a description of the work order, a status of the work order, a priority of the work order, and an asset description of the asset 330. Thus, the work order information may be populated within the user interface 335. The updated electronic site map 365 may display the device indicator located near an asset indicator of the asset 330 because the computing device 110 is now within communication range of the beacon device 325. In one embodiment, the asset information and/or the asset indicator of the asset 320 is no longer displayed because the computing device 110 is not within communication range of the beacon device 315. In other embodiments, the asset information and/or the asset indicator of the asset 320 is still displayed. Thus, the updated asset information 360 may comprise or exclude the asset information for the asset 320. In this way, the user interface 335 is updated with the updated asset information 360 and the updated electronic site map 365 depicting the device indicator as being located nearby the asset 330.

The computing device 110 may move to a location where the communication module 105 receives beacon signals from both the beacon device 315 and the beacon device 325, as illustrated by FIG. 3D. Accordingly, the communication module 105 retrieves updated asset information 370 for the asset 320 and the asset 330 and an updated site map 375 depicting the device indicator near the asset indicator of the asset 320 and the asset indicator of the asset 330.

In this way, asset information and asset indicators displayed through the user interface 335 are continually updated to include asset information and indictors of assets nearby the computing device 110 as the computing device 110 moves around the site 305.

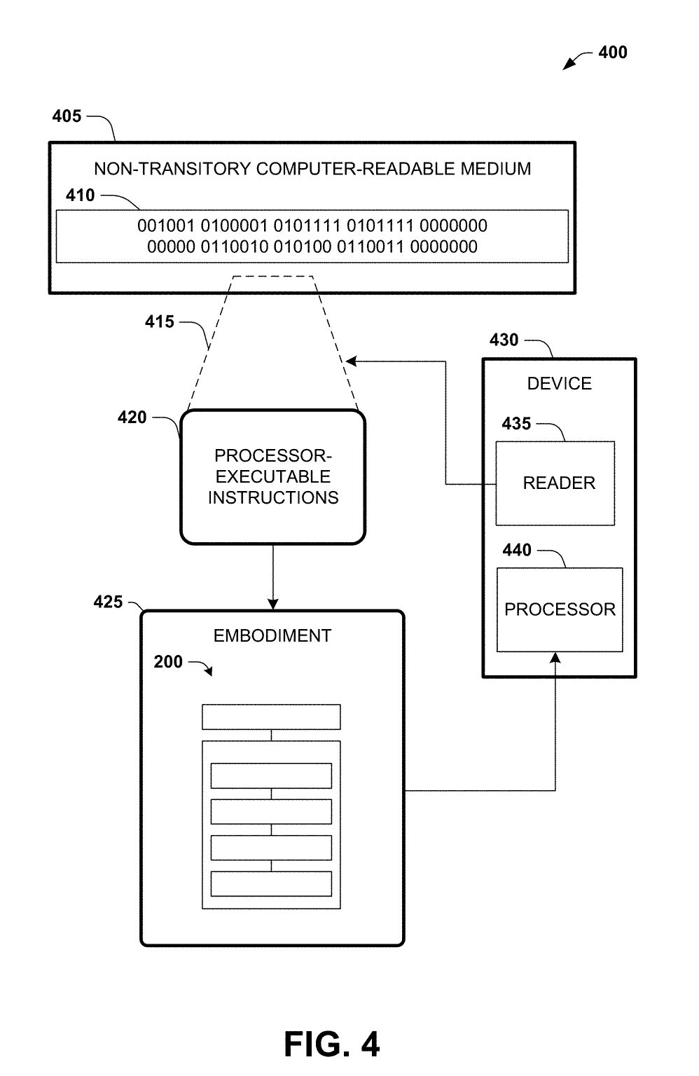

FIG. 4 is an illustration of a scenario 400 involving an example non-transitory computer-readable medium 405. In one embodiment, one or more of the components described herein are configured as program modules, such as the communication module 105, stored in the non-transitory computer-readable medium 405. The program modules are configured with stored instructions, such as processor-executable instructions 420, that when executed by at least a processor, such as processor 440, cause the computing device to perform the corresponding function(s) as described herein. In one embodiment, the, functionality of the communication module 105, stored in the non-transitory computer-readable medium 405, may be executed by the processor 440 as the processor-executable instructions 420 to perform an embodiment 425 of the method 200 of FIG. 2.

The non-transitory computer-readable medium 405 includes the processor-executable instructions 420 that when executed by a processor 440 cause performance of at least some of the provisions herein. The non-transitory computer-readable medium 405 includes a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory computer-readable medium 405 stores computer-readable data 410 that, when subjected to reading 415 by a reader 435 of a device 430 (e.g., a read head of a hard disk drive, or a read operation invoked on a solid-state storage device), express the processor-executable instructions 420.

In some embodiments, the processor-executable instructions 420, when executed cause performance of operations, such as at least some of the example method 200 of FIG. 2, for example. In some embodiments, the processor-executable instructions 420 are configured to cause implementation of a system, such as at least some of the example system 100 of FIG. 1, for example.

FIG. 5 illustrates an example computing device 500 that is configured and/or programmed with one or more of the example systems and methods described herein, and/or equivalents. The example computing device 500 may be the computer 515 that includes a processor 520, a memory 535, and I/O ports 545 operably connected by a bus 525. In one embodiment, the, the computer 515 may include logic of the communication module 105 configured to facilitate the system 100 and/or the method 200 shown in FIGS. 1-2. In different embodiments, the logic of the communication module 105 may be implemented in hardware, a non-transitory computer-readable medium 505 with stored instructions, firmware, and/or combinations thereof. While the logic of the communication module 105 is illustrated as a hardware component attached to the bus 525, it is to be appreciated that in other embodiments, the logic of the communication module 105 could be implemented in the processor 520, stored in memory 535, or stored in disk 555.

In one embodiment, logic of the communication module 105 or the computer 515 is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an application specific integrated circuit (ASIC) programmed to implement rule based source sequencing for allocation. The means may also be implemented as stored computer executable instructions that are presented to computer 515 as data 510 that are temporarily stored in memory 535 and then executed by processor 520.

The logic of the communication module 105 may also provide means (e.g., hardware, non-transitory computer-readable medium 505 that stores executable instructions, firmware) for performing rule based source sequencing for allocation.

Generally describing an example configuration of the computer 515, the processor 520 may be a variety of various processors including dual microprocessor and other multi-processor architectures. The memory 535 may include volatile memory and/or non-volatile memory. Non-volatile memory may include, for example, read-only memory (ROM), programmable read-only memory (PROM), and so on. Volatile memory may include, for example, random access memory (RAM), static random-access memory (SRAM), dynamic random access memory (DRAM), and so on.

The disks 555 may be operably connected to the computer 515 via, for example, the I/O interface 540 (e.g., card, device) and the I/O ports 545. The disks 555 may be, for example, a magnetic disk drive, a solid state disk drive, a floppy disk drive, a tape drive, a Zip drive, a flash memory card, a memory stick, and so on. Furthermore, the disks 555 may be a CD-ROM drive, a CD-R drive, a CD-RW drive, a DVD ROM, and so on. The memory 535 can store a process, such as within the non-transitory computer-readable medium 505, and/or data 510, for example. The disk 555 and/or the memory 535 can store an operating system that controls and allocates resources of the computer 515.

The computer 515 may interact with input/output (I/O) devices via the I/O interfaces 540 and the I/O ports 545. The I/O devices may be, for example, a keyboard, a microphone, a pointing and selection device, cameras, video cards, displays, the disks 555, the network devices 550, and so on. The I/O ports 545 may include, for example, serial ports, parallel ports, and USB ports. I/O controllers 530 may connect the I/O interfaces 540 to the bus 525.

The computer 515 can operate in a network environment and thus may be connected to the network devices 550 via the I/O interfaces 540, and/or the I/O ports 545. Through the network devices 550, the computer 515 may interact with a network. Through the network, the computer 515 may be logically connected to remote computers (e.g., the computer 515 may reside within a distributed computing environment to which clients may connect). Networks with which the computer 515 may interact include, but are not limited to, a local area network (LAN), a new area network (WAN), and other networks.

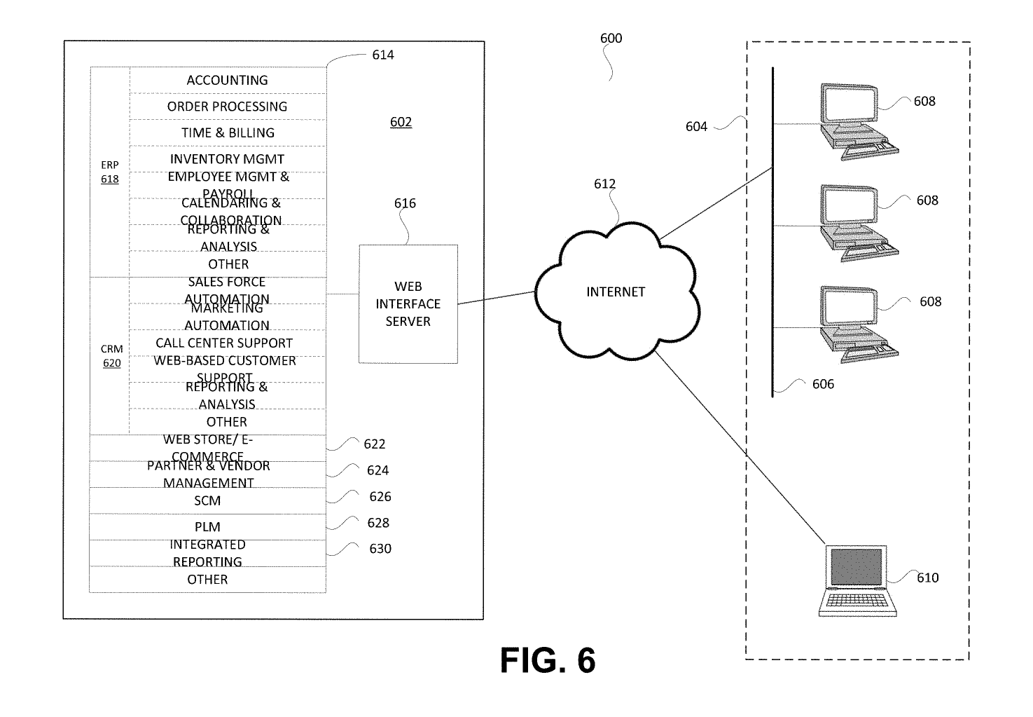

FIG. 6 is a diagram illustrating a system 600 in which an embodiment of the invention may be implemented. Enterprise network 604 may be associated with a business enterprise, such as a retailer, merchant, service provider, or other type of business. Alternatively, and in accordance with the advantages of an application service provider (ASP) hosted integrated business system (such as a multi-tenant data processing platform), the business enterprise may comprise fewer or no dedicated facilities or business network at all, provided that its end users have access to an internet browser and an internet connection. For simplicity and clarity of explanation, the enterprise network 604 is represented by an on-site local area network 606 to which a plurality of personal computers 608 are connected, each generally dedicated to a particular end user, such as a service agent or other employee (although such dedication is not required), along with an exemplary remote user computer 610 that can be, for example, a laptop computer or tablet computer of a traveling employee having internet access through a public Wi-Fi access point, or other internet access method. The end users (consumers) associated with computers 608 and 610 may possess an internet-enabled smartphone or other electronic device (such as a PDA, tablet, laptop computer) having wireless internet access or other synchronization capabilities. Users of the enterprise network 604 interface with the integrated business system 602 across the Internet 612 or another suitable communications network or combination of networks.

Integrated business system 602, which may be hosted by a dedicated third party, may include an integrated business server 614 and a web interface server 616, coupled as shown in FIG. 6. It is to be appreciated that either or both of the integrated business server 614 and the web interface server 616 may be implemented on one or more different hardware systems and components, even though represented as singular units in FIG. 6.

In a typical example in which system 602 is operated by a third party for the benefit of multiple account owners/tenants, each of whom is operating a business, integrated business server 614 comprises an ERP module 618 and further comprises a CRM module 620. In many cases, it will be desirable for the ERP module 618 to share methods, libraries, databases, subroutines, variables, etc., with CRM module 620, and indeed ERP module 618 may be intertwined with CRM module 620 into an integrated Business Data Processing Platform (which may be single tenant, but is typically multi-tenant).

The ERP module 618 may include, but is not limited to, a finance and accounting module, an order processing module, a time and billing module, an inventory management and distribution module, an employee management and payroll module, a calendaring and collaboration module, a reporting and communication module, and other ERP-related modules. The CRM module 620 may include, but is not limited to, a sales force automation (SFA) module, a marketing automation module, a contact list module (not shown), a call center support module, a web-based customer support module, a reporting and communication module, and other CRM-related modules. The integrated business server 614 (or multi-tenant data processing platform) further may provide other business functionalities including a web store/eCommerce module 622, a partner and vendor management module 624, and an integrated reporting module 630. An SCM (supply chain management) module 626 and PLM (product lifecycle management) module 628 may also be provided. Web interface server 616 is configured and adapted to interface with the integrated business server 614 to provide one or more web-based user interfaces to end users of the enterprise network 604.

The integrated business system shown in FIG. 6 may be hosted on a distributed computing system made up of at least one, but likely multiple, “servers.” A server is a physical computer dedicated to providing data storage and an execution environment for one or more software applications or services intended to serve the needs of the users of other computers that are in data communication with the server, for instance via a public network such as the Internet or a private “intranet” network. The server, and the services it provides, may be referred to as the “host” and the remote computers, and the software applications running on the remote computers, being served may be referred to as “clients.” Depending on the computing service(s) that a server offers it could be referred to as a database server, data storage server, file server, mail server, print server, web server, etc. A web server is a most often a combination of hardware and the software that helps deliver content, commonly by hosting a website, to client web browsers that access the web server via the Internet.

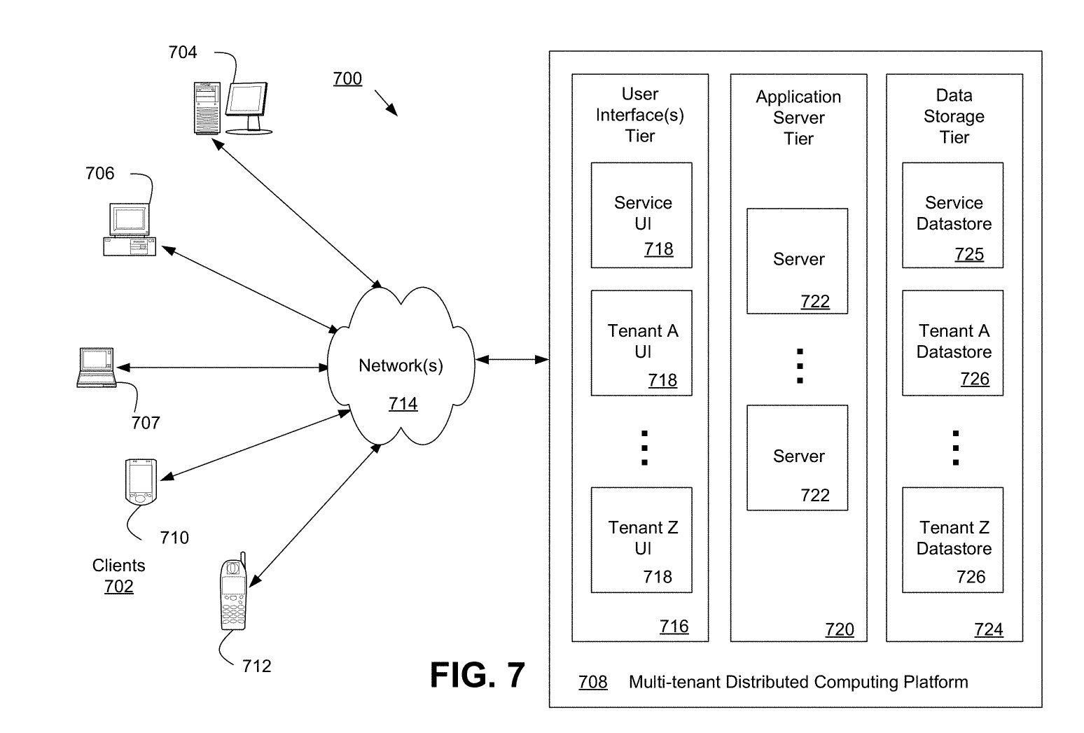

FIG. 7 is a diagram illustrating elements or components of an example operating environment 700 in which an embodiment of the invention may be implemented. As shown, a variety of clients 702 incorporating and/or incorporated into a variety of computing devices may communicate with a distributed computing service/platform 708 through one or more networks 714. For example, a client may incorporate and/or be incorporated into a client application (e.g., software) implemented at least in part by one or more of the computing devices. Examples of suitable computing devices include personal computers, server computers 704, desktop computers 706, laptop computers 708, notebook computers, tablet computers or personal digital assistants (PDAs) 710, smart phones 712, cell phones, and consumer electronic devices incorporating one or more computing device components, such as one or more electronic processors, microprocessors, central processing units (CPU), or controllers. Examples of suitable networks 714 include networks utilizing wired and/or wireless communication technologies and networks operating in accordance with any suitable networking and/or communication protocol (e.g., the Internet). In use cases involving the delivery of customer support services, the computing devices noted represent the endpoint of the customer support delivery process, i.e., the consumer's device.

The distributed computing service/platform (which may also be referred to as a multi-tenant business data processing platform) 708 may include multiple processing tiers, including a user interface tier 716, an application server tier 720, and a data storage tier 724. The user interface tier 716 may maintain multiple user interfaces 718, including graphical user interfaces and/or web-based interfaces. The user interfaces may include a default user interface for the service to provide access to applications and data for a user or “tenant” of the service (depicted as “Service UI” in the figure), as well as one or more user interfaces that have been specialized/customized in accordance with user specific requirements (e.g., represented by “Tenant A UI”, . . . , “Tenant Z UI” in the figure, and which may be accessed via one or more APIs). The default user interface may include components enabling a tenant to administer the tenant's participation in the functions and capabilities provided by the service platform, such as accessing data, causing the execution of specific data processing operations, etc. Each processing tier shown in the figure may be implemented with a set of computers and/or computer components including computer servers and processors, and may perform various functions, methods, processes, or operations as determined by the execution of a software application or set of instructions. The data storage tier 724 may include one or more data stores, which may include a Service Data store 725 and one or more Tenant Data stores 726.

Each tenant data store 726 may contain tenant-specific data that is used as part of providing a range of tenant-specific business services or functions, including but not limited to ERP, CRM, eCommerce, Human Resources management, payroll, etc. Data stores may be implemented with any suitable data storage technology, including structured query language (SQL) based relational database management systems (RDBMS).

In accordance with one embodiment of the invention, distributed computing service/platform 708 may be multi-tenant and service platform 708 may be operated by an entity in order to provide multiple tenants with a set of business related applications, data storage, and functionality. These applications and functionality may include ones that a business uses to manage various aspects of its operations. For example, the applications and functionality may include providing web-based access to business information systems, thereby allowing a user with a browser and an Internet or intranet connection to view, enter, process, or modify certain types of business information.

As noted, such business information systems may include an Enterprise Resource Planning (ERP) system that integrates the capabilities of several historically separate business computing systems into a common system, with the intention of streamlining business processes and increasing efficiencies on a business-wide level. By way of example, the capabilities or modules of an ERP system may include (but are not required to include, nor limited to only including): accounting, order processing, time and billing, inventory management, retail point of sale (POS) systems, eCommerce, product information management (PIM), demand/material requirements planning (MRP), purchasing, content management systems (CMS), professional services automation (PSA), employee management/payroll, human resources management, and employee calendaring and collaboration, as well as reporting and analysis capabilities relating to these functions. Such functions or business applications are typically implemented by one or more modules of software code/instructions that are maintained on and executed by one or more servers 722 that are part of the platform's Application Server Tier 720.

Another business information system that may be provided as part of an integrated data processing and service platform is an integrated Customer Relationship Management (CRM) system, which is designed to assist in obtaining a better understanding of customers, enhance service to existing customers, and assist in acquiring new and profitable customers. By way of example, the capabilities or modules of a CRM system can include (but are not required to include, nor limited to only including): sales force automation (SFA), marketing automation, contact list, call center support, returns management authorization (RMA), loyalty program support, and web-based customer support, as well as reporting and analysis capabilities relating to these functions. In addition to ERP and CRM functions, a business information system/platform (such as element 708 of FIG. 7(A)) may also include one or more of an integrated partner and vendor management system, eCommerce system (e.g., a virtual storefront application or platform), product lifecycle management (PLM) system, Human Resources management system (which may include medical/dental insurance administration, payroll, etc.), or supply chain management (SCM) system. Such functions or business applications are typically implemented by one or more modules of software code/instructions that are maintained on and executed by one or more servers 722 that are part of the platform's Application Server Tier 720.

Note that both functional advantages and strategic advantages may be gained through the use of an integrated business system comprising ERP, CRM, and other business capabilities, as for example where the integrated business system is integrated with a merchant's eCommerce platform and/or “web-store.” For example, a customer searching for a particular product can be directed to a merchant's website and presented with a wide array of product and/or services from the comfort of their home computer, or even from their mobile phone. When a customer initiates an online sales transaction via a browser-based interface, the integrated business system can process the order, update accounts receivable, update inventory databases and other ERP-based systems, and can also automatically update strategic customer information databases and other CRM-based systems. These modules and other applications and functionalities may advantageously be integrated and executed by a single code base accessing one or more integrated databases as necessary, forming an integrated business management system or platform (such as platform 708 of FIG. 7).

As noted with regards to FIG. 6, the integrated business system shown in FIG. 7 may be hosted on a distributed computing system made up of at least one, but typically multiple, “servers.” A server is a physical computer dedicated to providing data storage and an execution environment for one or more software applications or services intended to serve the needs of the users of other computers that are in data communication with the server, for instance via a public network such as the Internet or a private “intranet” network.

Rather than build and maintain such an integrated business system themselves, a business may utilize systems provided by a third party. Such a third party may implement an integrated business system/platform as described above in the context of a multi-tenant platform, wherein individual instantiations of a single comprehensive integrated business system are provided to a variety of tenants. One advantage to such multi-tenant platforms is the ability for each tenant to customize their instantiation of the integrated business system to that tenant's specific business needs or operational methods. Each tenant may be a business or entity that uses the multi-tenant platform to provide business data and functionality to multiple users. Some of those multiple users may have distinct roles or responsibilities within the business or entity.

In some cases, a tenant may desire to modify or supplement the functionality of an existing platform application by introducing an extension to that application, where the extension is to be made available to the tenant's employees and/or customers. In some cases, such an extension may be applied to the processing of the tenant's business related data that is resident on the platform. The extension may be developed by the tenant or by a 3rd party developer and then made available to the tenant for installation. The platform may include a “library” or catalog of available extensions, which can be accessed by a tenant and searched to identify an extension of interest. Software developers may be permitted to “publish” an extension to the library or catalog after appropriate validation of a proposed extension.

Thus, in an effort to permit tenants to obtain the services and functionality that they desire (which may include providing certain services to their end customers, such as functionality associated with an eCommerce platform), a multi-tenant service platform may permit a tenant to configure certain aspects of the available service(s) to better suit their business needs. In this way aspects of the service platform may be customizable, and thereby enable a tenant to configure aspects of the platform to provide distinctive services to their respective users or to groups of those users. For example, a business enterprise that uses the service platform may want to provide additional functions or capabilities to their employees and/or customers, or to cause their business data to be processed in a specific way in accordance with a defined workflow that is tailored to their business needs, etc.

Tenant customizations to the platform may include custom functionality (such as the capability to perform tenant or user-specific functions, data processing, or operations) built on top of lower level operating system functions. Some multi-tenant service platforms may offer the ability to customize functions or operations at a number of different levels of the service platform, from aesthetic modifications to a graphical user interface to providing integration of components and/or entire applications developed by independent third party vendors. This can be very beneficial, since by permitting use of components and/or applications developed by third party vendors, a multi-tenant service can significantly enhance the functionality available to tenants and increase tenant satisfaction with the platform.

As noted, in addition to user customizations, an independent software developer may create an extension to a particular application that is available to users through a multi-tenant data processing platform. The extension may add new functionality or capabilities to the underlying application. One or more tenants/users of the platform may wish to add the extension to the underlying application in order to be able to utilize the enhancements to the application that are made possible by the extension. Further, the developer may wish to upgrade or provide a patch to the extension as they recognize a need for fixes or additional functionality that would be beneficial to incorporate into the extension. In some cases, the developer may prefer to make the upgrade available to only a select set of users (at least initially) in order to obtain feedback for improving the newer version of the extension, to test the stability of the extension, or to assist them to segment the market for their extension(s).

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks. The methods described herein are limited to statutory subject matter under 35 U.S.C § 101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions. Computer-readable media described herein are limited to statutory subject matter under 35 U.S.C § 101.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions. Logic is limited to statutory subject matter under 35 U.S.C. § 101.

An “operable connection”, or a connection by which entities are “operably connected”, is one in which signals, physical communications, and/or logical communications may be sent and/or received. An operable connection may include a physical interface, an electrical interface, and/or a data interface. An operable connection may include differing combinations of interfaces and/or connections sufficient to allow operable control. For example, two entities can be operably connected to communicate signals to each other directly or through one or more intermediate entities (e.g., processor, operating system, logic, non-transitory computer-readable medium). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

Thus, this disclosure is intended to embrace alterations, modifications, and variations that fall within the scope of the appended claims, which satisfy the statutory subject matter requirements of 35 U.S.C. § 101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

What is claimed is:

1. A non-transitory computer-readable medium storing computer-executable instructions that when executed by a processor of a computing device causes the processor to:
control a wireless receiver of the computing device to listen for beacon signals transmitted by beacon devices located at different locations within a site;
in response to receiving, by the wireless receiver, a first beacon signal from a first beacon device located at the site:
evaluate the first beacon signal to identify a site identifier of the site;
transmit, over a network, a request comprising the site identifier to a remote computing system for requesting asset information of assets located at the site;
receive the asset information over the network from the remote computing device;
construct a user interface populated with the asset information to indicate locations of assets within the site relative to the computing device so that assets can be located within the site by a user; and
render the user interface on a display of the computing device; and
generate a route, using the user interface, on the display through the site to a target asset, wherein locations of assets provided through the user interface are updated based upon changes in location of the computing device within the site.

2. The non-transitory computer-readable medium of claim 1, wherein the request comprises a request for an electronic site map of the site, and wherein the instructions comprise instructions to:
receive the electronic site map of the site over the network from the remote computing device;
render the electronic site map through the user interface;
continuously monitor, by the wireless receiver, to detect beacon signals from the beacon devices;
in response to the computing device changing locations in the site and detecting a different beacon signal of a different beacon device, transmitting a subsequent request to retrieve an updated electronic site map based on an identifier of the different beacon device identified from the different beacon signal;
modifying the user interface with the updated electronic site map; and
updating the electronic site map upon each occurrence of detecting a new beacon signal from the beacon devices within the site.

3. The non-transitory computer-readable medium of claim 1, wherein the request comprises a request for an electronic site map of the site, and wherein the instructions comprise instructions to:
receive the electronic site map of the site over the network from the remote computing device;
render the electronic site map through the user interface;
utilize locational information of one or more beacon signals received from the beacon devices to determine a current location of the computing device within the site;
evaluate the asset information and asset location information of one or more beacon signals received from the beacon devices to determine current locations of the assets within the site;
populate the electronic site map with a device indicator to indicate the current location of the computing device within the site; and
populate the electronic site map with asset indicators to indicate the current locations of the assets within the site.

4. The non-transitory computer-readable medium of claim 3, wherein the instructions comprise instructions to:
update the current location of the device indicator within the electronic site map based upon one or more additional beacon signals received from the beacon devices, wherein the one or more additional beacon signals are indicative of locational changes of the computing device within the site.

5. The non-transitory computer-readable medium of claim 3, wherein the instructions comprise instructions to:
continuously update the asset information populated within the user interface to comprise asset information of assets within a threshold distance of the computing device as the computing device changes locations in the site, wherein an asset is within the threshold distance of the computing device when a beacon signal of a beacon device for the asset is received.

6. The non-transitory computer-readable medium of claim 1, wherein the instructions comprise instructions to:
in response to receiving the first beacon signal, render a site description user interface populated with a description of the site.

7. The non-transitory computer-readable medium of claim 1, wherein the instructions comprise instructions to:
receive a selection of an asset from the user interface;
retrieve a work order for the asset from the remote computing device over the network; and
populate the user interface with the work order.

8. The non-transitory computer-readable medium of claim 7, wherein the instructions comprise instructions to:
evaluate input through the user interface to determine that the input corresponds to a modification to the work order; and
transmit the modification to the remote computing device over the network to modify the work order based upon the modification.

9. A computing system, comprising:
a processor connected to memory; and
a communication module stored on a non-transitory computer readable medium and configured with instructions that when executed by the processor cause the processor to:
control a wireless receiver of a computing device to listen for beacon signals transmitted by beacon devices located at different locations within a site;
in response to receiving, by the wireless receiver, a first beacon signal from a first beacon device located at the site:
evaluate the first beacon signal to identify a site identifier of the site;
transmit, over a network, a request comprising the site identifier to a remote computing system for requesting asset information of assets located at the site;
receive the asset information over the network from the remote computing device;
construct a user interface populated with the asset information to indicate locations of assets within the site relative to the computing device so that assets can be located within the site by a user; and
render the user interface on a display of the computing device; and
generate a route, using the user interface, on the display through the site to a target asset, wherein locations of assets provided through the user interface are updated based upon changes in location of the computing device within the site.

10. The computing system of claim 9, wherein the request comprises a request for an electronic site map of the site, and wherein the instructions comprise instructions that cause the processor to:
receive the electronic site map of the site over the network from the remote computing device;
render the electronic site map through the user interface;
populate the electronic site map with a device indicator to indicate locations of the computing device within the site relative to locations of assets within the site as the computing device changes locations in the site; and
populate the electronic site map with asset indicators to indicate current locations of the assets within the site.

11. The computing system of claim 10, wherein the instructions comprise instructions that cause the processor to:
continuously monitor, by the wireless receiver, to detect beacon signals from the beacon devices;
in response to the computing device changing locations in the site and detecting a different beacon signal of a different beacon device, transmitting a subsequent request to retrieve an updated electronic site map based on an identifier of the different beacon device identified from the different beacon signal;
modifying the user interface with the updated electronic site map; and
updating the electronic site map upon each occurrence of detecting a new beacon signal from the beacon devices within the site.

12. The computing system of claim 10, wherein each asset is associated with a beacon device, and wherein the instructions comprise instructions that cause the processor to:
populate the electronic site map with asset indicators of assets that are within a threshold distance of the computing device, wherein the threshold distance corresponds to a distance over which the computing device is capable of receiving beacon signals from beacon devices associated with corresponding assets.

13. The computing system of claim 10, wherein the instructions comprise instructions that cause the processor to:
receive input through the user interface, wherein the input corresponds to a selection of an asset; and
populate the electronic site map with a path from the current location of the computing device to a current location of the asset.

14. The computing system of claim 9, wherein the instructions comprise instructions that cause the processor to:
receive a second beacon signal from a second beacon device;
evaluate the second beacon signal to identify an asset identifier of an asset associated with the second beacon device;
retrieve asset information of the asset from the remote computing system over the network, wherein the asset information comprises at least one of an asset description or a work order for the asset; and
populating the user interface with at least one of the asset description or the work order.

15. A computer-implemented method, the computer-implemented method involving a computing device comprising a processor, and the computer-implemented method comprising:
controlling, by the processor, a wireless receiver of the computing device to listen for beacon signals transmitted by beacon devices located at different locations within a site;
in response to receiving, by the wireless receiver, a first beacon signal from a first beacon device located at the site:
evaluating, by the processor, the first beacon signal to identify a site identifier of the site;
transmitting, by the processor over a network, a request comprising the site identifier to a remote computing system for requesting asset information of assets located at the site;
receiving, by the processor, the asset information over the network from the remote computing device;
constructing, by the processor, a user interface populated with the asset information to indicate locations of assets within the site relative to the computing device so that assets can be located within the site by a user; and
rendering, by the processor, the user interface on a display of the computing device; and
generate a route, by the processor using the user interface, on the display through the site to a target asset, wherein locations of assets provided through the user interface are updated based upon changes in location of the computing device within the site.

16. The computer-implemented method of claim 15, further comprising:
invoking a representational state transfer (REST) application programming interface (API) to transmit the request to an enterprise resource planning (ERP) system hosted by the remote computing device.

17. The computer-implemented method of claim 15, wherein the request comprises a request for an electronic site map of the site, and the method further comprising:
receiving the electronic site map of the site over the network from the remote computing device;
rendering the electronic site map through the user interface;
populating the electronic site map with a device indicator to indicate a current location of the computing device within the site;
populating the electronic site map with an orientation of the computing device, a location accuracy of the electronic site map, and coordinates of the computing device; and
populating the electronic site map with asset indicators to indicate current locations of the assets within the site.

18. The computer-implemented method of claim 15, further comprising:
receiving a selection of an asset from the user interface;
retrieving a work order for the asset from the remote computing device over the network; and
populating the user interface with the work order comprising a work order number of the work order, a description of the work order, a status of the work order, a priority of the work order, and an asset description of the asset.

19. The computer-implemented method of claim 15, further comprising:
parsing a first portion of the first beacon signal to identify an identifier of the first beacon device, a second portion of the first beacon signal to identify a major number mapped to the site identifier, and a third beacon portion of the signal to identify a minor number mapped to an asset identifier of an asset associated with the first beacon device;
utilizing the identifier of the first beacon device and the asset identifier of the asset to determine that the first beacon device and the asset are within a threshold distance of the computing device; and
populating the user interface with a beacon indicator for the first beacon device and an asset indicator for the asset.

20. The computer-implemented method of claim 15, further comprising:
populating the user interface with a work order for an asset based upon the asset being within a threshold distance of the computing device.
